(19) United States
(12) Patent Application Publication
(10) Pub. No.: US 2017/0077496 A1
(43) Pub. Date: Mar. 16, 2017

(54) METAL GRADIENT-DOPED CATHODE MATERIAL FOR LITHIUM BATTERIES AND ITS PRODUCTION METHOD

(71) Applicant: FU JEN CATHOLIC UNIVERSITY, New Taipei City (TW)

(72) Inventors: Mao-Huang LIU, New Taipei City (TW); Chien-Wen JEN, New Taipei City (TW); Hsin-Ta HUANG, New Taipei City (TW); Cong-Min LIN, New Taipei City (TW)

(73) Assignee: FU JEN CATHOLIC UNIVERSITY, New Taipei City (TW)

(21) Appl. No.: 14/851,948

(22) Filed: Sep. 11, 2015

(51) Int. Cl. H01M 4/36; H01M 4/38; H01M 4/525; H01M 10/052; H01M 4/505

(52) U.S. Cl. CPC H01M 4/362; H01M 10/052; H01M 4/505; H01M 4/525; H01M 4/38

(57) ABSTRACT

Disclosed is a metal gradient-doped cathode material for lithium ion batteries including a hexagonal-crystalline material body and a modifying metal. The metal gradient-doped cathode material is formed by coating modifying metal hydroxide on the surface of the hexagonal-crystalline material using a chemical co-precipitation method, then sintering the modifying metal hydroxide coated hexagonal-crystalline material. The modifying metal is different from the active metals, more concentrated on the surface, and gradually decreases toward the core of particle. A gradient-doped distribution is formed without any boundary or layered structure in the particle. The surface of the powder with more the modifying metal can effectively reduce the reactivity of the cathode material with the electrolyte in the lithium battery. Thus, the overall operation-stability and safety of lithium batteries are improved, and only a little amount of the modifying metal is needed, thereby avoiding the reduction of capacity and increasing the rate-capability and cycle-life.

### BACKGROUND OF THE INVENTION

1. Field of the Invention

The present invention generally relates to a metal gradient-doped cathode material for lithium batteries, a method for preparing same, and more specifically to a cathode material comprising a modifying metal formed of at least one of magnesium (Mg), calcium (Ca), strontium (Sr), boron (B), aluminum (Al), gallium (Ga), indium (In), titanium (Ti), silicon (Si) and tin (Sn) in a gradient of concentration so as to improve the capacity, cycle-life and safety of lithium battery.

2. The Prior Arts

Recently, as the problem of global warming and the energy crisis of petroleum decrease become more serious, people have made many efforts to develop electric vehicles with more energy saving, carbon reducing and environmental protection. To meet environmental protection and energy saving, one of the best driving power sources for the electric vehicles is the high energy-density lithium battery with more safety. Many advanced countries around the world like America, Europe, Japan, Korea, China and Taiwan have aggressively spent various resources in researching and developing related technology for more powerful electric vehicles and lithium batteries for mass production. Additionally, the industry of 3C consumer electronic products made much progress, and smart phones and tablet PC have become more popular and almost a must-have for everybody to carry around and perform some mobile and smart functions like wireless on-line surfing, video playing and cloud information receiving. As a result, it is crucial to prolong the running time of the power source for the 3C electronic products, and thus needs to develop higher energy-density batteries to meet the requirement of electric vehicles and 3C products. The above properties of the lithium battery are strongly related to the active materials of electrodes, especially the cathode material.

Since the cathode material greatly influences the performance of the lithium battery, not only low cost, high capacity, long cycle-life and large charge/discharge current are necessary, but also thermal stability, thereby improving operation safety for the battery. Among current cathode materials, the hexagonal-crystalline material draws more attention because of higher energy-density. Lithium cobalt oxide (LiCoO₂) is one of the most commonly-used cathode materials. However, Co is a strategic material, costly, hard available and toxic. Such that another material, lithium nickel oxide (LiNiO₂), with high energy-density, low cost and less toxic has been studied to replace LiCoO₂. Currently, LiNiO₂ still has some troublesome problems like difficult synthesis, poor thermal-stability and unstable lattice structure. To overcome these issues, part of Ni in LiNiO₂ is replaced by Co, and the stability of lattice structure is enhanced. Such a hexagonal-crystalline cathode material, LiNiₓCo₁₋ₓO₂, exhibits higher capacity (larger than 180 mAh g⁻¹) and better thermal-stability than LiNiO₂, and becomes one of the most crucial materials for the next generation of the lithium battery. While this cathode material has many advantages, some low-cost cathode materials like LiNiₓCo_{y}Mn_{1-x-y}O₂ have been progressively developed. The LiNiₓCo_{y}Mn_{1-x-y}O₂ cathode material has lower capacity than the LiNiₓCo₁₋ₓO₂ cathode material, but its material cost, cyclability and safety can be further improved by adding Mn.

Currently, there are two approaches to develop high energy-density cathode material. One approach is focused on the Ni-rich material to increase its capacity. The other is to increase working-voltage like larger than 4.2 V so as to increase its capacity.

While the cathode material with the hexagonal-crystalline structure has higher capacity and is widely used in the lithium battery, however, it easily reacts with the electrolyte on the surface of powder, leading to short cycle-life and poor safety.

In the prior arts, many researchers tried to enhance stability of the hexagonal-crystalline cathode material for lithium battery by adding some more stable modifying materials. Such the modifying materials are different from the active metals like Ni, Co and Mn in the hexagonal-crystalline body.

Specifically, two modifying processes are more commonly used, including surface coating and metal doping.

As for the surface coating method, the cathode material is basically coated with a nano-layer of non-electrochemical active material to reduce the reactivity with the electrolyte, thereby prolong the cycle-life of battery. However, it is still difficult and uneasy for current technology to uniformly coat a nanometer protective layer on the surface of cathode material. As a result, industrial utility is greatly reduced.

The metal doping method employs some non-electrochemical active metal to uniformly dope into the crystal structure of cathode material so as to enhance the stability of material. However, more amount of the modifying metal is needed to effectively suppress the reactivity of the cathode material with the electrolyte, and the original advantage of high capacity is thus reduced.

Therefore, it is greatly needed to provide a metal gradient-doped cathode material for lithium batteries, in which a less-amount modifying metal is used to improve the stability of material, so as to manufacture lithium batteries with high capacity, good cyclability and high-safety, thereby overcoming the above problems in the prior arts.

### SUMMARY OF THE INVENTION

The primary objective of the present invention is to provide a metal gradient-doped cathode material for lithium batteries. The cathode material of the present invention is basically a powder particle without any boundary or layered structure and the powder generally comprises a hexagonal-crystalline material body and a modifying metal doped in the hexagonal-crystalline material body. In particular, the modifying metal is doped in a gradient of concentration. Specifically, the metal gradient-doped cathode material is expressed by a chemical formula “f mol % M doped Li_{z}NiₐCo_{b}Mn_{c}O₂”, where Li_{z}NiₐCo_{b}Mn_{c}O₂ represents the hexagonal-crystalline material body, M represents the modifying metal, which has a molar content f larger than 0.5% and smaller than 10% of the sum of molar content of Ni (nickel), Co (cobalt) and Mn (manganese) in the hexagonal-crystalline material body, specified by 0.5% (a+b+c)≦f≦10% (a+b+c).

The hexagonal-crystalline material body, Li_{z}NiₐCo_{b}Mn_{c}O₂, as an active component of cathode material comprises a lithium metal oxide of a single metal selected from Ni and Co, or two metals selected from Ni/Co, Ni/Mn and Co/Mn, or three metals comprising Ni, Co and Mn, where z, a, b and c in the chemical formula are specified by 0.9≦z≦1.2, a+b+c=1, 0≦a≦1, 0≦b≦1 and 0≦c≦0.6. The modifying metal is a metal or a metalloid selected from at least one of magnesium (Mg), calcium (Ca), strontium (Sr), boron (B), aluminum (Al), gallium (Ga), indium (In), titanium (Ti), silicon (Si) and tin (Sn). Especially, the modifying metal is more concentrated on the surface of the powder and gradually decreases toward the core of the powder so as to form a gradient profile of concentration. The concentration of modifying metal on the surface of the powder, is expressed as f′, the concentration of the modifying metal at the core of the powder, is expressed as f″, and the concentration ranges of modifying metal are f′>f>f″>0 and f′−f″>0.2% (a+b+c). The surface of the powder with more the modifying metal can effectively reduce the reactivity of the cathode material with the electrolyte in the lithium battery. As a result, the cyclability and safety for the lithium battery is greatly improved. In particular, less amount of the modifying metal is enough to achieve the desired effect so as to avoid the traditional problem that more amount of the modifying metal greatly reduces the capacity of the battery, thereby increasing the energy-density and cycle-life of the lithium battery. The metal gradient-doped cathode material is formed by coating modifying metal hydroxide on the surface of the hexagonal-crystalline material by a chemical co-precipitation method, and then sintering the modifying metal hydroxide coated hexagonal-crystalline material.

More specifically, the cathode material of the present invention exhibits not only the aspect that the reactivity of the cathode material with the electrolyte is effectively reduced by adding less amount of the modifying metal, but also the advantage that electrochemical performance and thermal stability are improved and the overall efficiency, cycle-life and industrial utility of the battery are increased.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a structure diagram of the metal gradient-doped cathode material in accordance with the present invention;

FIGS. 2a and 2b show the morphology and aluminum distribution of surface, and FIGS. 2c and 2d show the morphology and aluminum compositional change of the cross section of the metal gradient-doped cathode material Al(GD)-LNCO as the illustrative example 1 according to the first embodiment of the present invention;

FIG. 3 is a comparison diagram in the initial charge-discharge curves of the illustrative example 1 and the comparative example 1 in the voltage ranges of 2.8˜43 V and 2.8˜45 Vat current level of 0.1 C;

FIG. 4 is a comparison diagram in the discharge capability at various currents between (a) the comparative example 1 and (b) the illustrative example 1;

FIG. 5 is a comparison diagram in cycle-life of (a) the comparative example 1 and (b) the illustrative example 1;

FIG. 6 is a comparison diagram tested by a differential scanning calorimeter with regard to released heat-flow of (a) the comparative example 1 and (b) the illustrative example 1;

FIGS. 7a and 7b show the morphology and magnesium distribution of surface, and FIGS. 7c and 7d show the morphology and magnesium compositional change of the cross section of the metal gradient-doped cathode material Mg(GD)-LNCMO as the illustrative example 2 according to the second embodiment of the present invention;

FIG. 8 is a comparison diagram in the initial charge-discharge curves of the illustrative example 2 and the comparative example 2 in the voltage ranges of 2.8˜43 V and 2.8˜45 V at current level of 0.1 C;

FIG. 9 is a comparison diagram in the discharge capability at various currents between (a) the comparative example 2 and (b) the illustrative example 2;

FIG. 10 is a comparison diagram in cycle-life of (a) the comparative example 2 and (b) the illustrative example 2; and

FIG. 11 is a comparison diagram tested by a differential scanning calorimeter with regard to released heat-flow of (a) the comparative example 2 and (b) the illustrative example 2.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

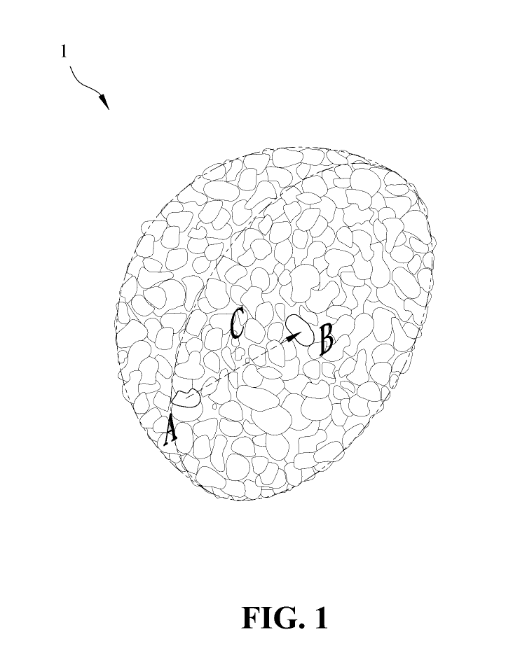

Please refer to FIG. 1 showing the metal gradient-doped cathode material for lithium batteries according to the present invention. As shown in FIG. 1, the metal gradient-doped cathode material 1 of the present invention is substantially a form of powder, and generally comprises a hexagonal-crystalline cathode material body and a modifying metal doped in a gradient of concentration. The powder particle of the present invention does not have any boundary or layered structure. Specifically, the metal gradient-doped cathode material 1 is specified by a chemical formula “f mol % M doped Li_{z}NiₐCo_{b}Mn_{c}O₂”, where Li_{z}NiₐCo_{b}Mn_{c}O₂ represents the hexagonal-crystalline material body, and M represents the modifying metal having a molar content f larger than 0.5% and smaller than 10% of a total molar content of Ni, Co and Mn in the hexagonal-crystalline material body, or alternatively expressed as 0.5% (a+b+c)≦f≦10% (a+b+c).

The hexagonal-crystalline material body of the metal gradient-doped cathode material comprises a lithium metal oxide of a single metal selected from Ni and Co, or two metals selected from Ni/Co, Ni/Mn and Co/Mn, or three metals comprising Ni, Co and Mn, where z, a, b and c in the chemical formula Li_{z}NiₐCo_{b}Mn_{c}O₂ are specified by 0.9≦z≦1.2, a+b+c=1, 0≦a≦1, 0≦b≦1 and 0≦c≦0.6. More specifically, the hexagonal-crystalline material body is doped with the modifying metal, which is configured in a continuously variation of concentration. In particular, the modifying metal is different from the active metal like Ni, Co and Mn, and exhibits weaker reactivity with the electrolyte used in lithium batteries.

It is preferred that the modifying metal comprises a metal or a metalloid selected from at least one of magnesium (Mg), calcium (Ca), strontium (Sr), boron (B), aluminum (Al), gallium (Ga), indium (In), titanium (Ti), silicon (Si) and tin (Sn). In particular, the modifying metal is more concentrated on the surface A and continuously decreases toward the core B in a direction indicated by C, and a gradient of concentration is thus formed. The concentration of modifying metal on the surface A of the powder, is expressed as f′, the concentration of the modifying metal at the core B of the powder, is expressed as f″, and the concentration ranges of modifying metal are f′>f>f″>0 and f′−f″>0.2% (a+b+c).

The metal gradient-doped cathode material is formed by coating modifying metal hydroxide on the surface of the hexagonal-crystalline material by a chemical co-precipitation method, and then sintering the modifying metal hydroxide coated hexagonal-crystalline material.

In addition, the metal gradient-doped cathode material of the present invention is a R-3m space group. The D₅₀ particle size of powder is 0.5˜25 μm. For instance, the concentration of the modifying metal varieties around the region of, a half of the D₅₀ particle size of powder, that is, from 0.25 to 12.5 μm. The metal gradient-doped cathode material has a tap density larger than 1.5 g cm ³, and its specific surface area is 0.1˜25 m² g⁻¹.

Some illustrative examples as preferred embodiments and comparative examples will be described in detail for physical and electrochemical properties to more clearly demonstrate the effects implemented by the present invention.

### ILLUSTRATIVE EXAMPLE 1

1. Synthesis of the lithium nickel cobalt oxide cathode material gradient-doped with aluminum as the modifying metal: A chemical co-precipitation method is used to synthesize spherical nickel cobalt hydroxide (N_{0.82}Co_{0.18}(OH)₂). An aqueous solution of 1.2 M NiSO₄ and CoSO₄ (molar ratio of Ni:Co 4:1) is pumped into a tank reactor (capacity, 2 L) with continuous stirring. Simultaneously, a 2.0 M NaOH solution and an 8.0 M NH₄OH solution, which is used as a chelating agent, are fed separately into the reactor. The concentration of NH₄OH, pH and temperature are maintained at 1.2 M, 10.5 and 60° C., respectively. After vigorous stirring for 20 hours, spherical Ni_{0.82}Co_{0.18}(OH)₂ precipitations with particle diameters of approximately 10˜15 μm are formed. Then, lithium hydroxide (LiOH.H₂O) is added and mixed, where a molar ratio of lithium salt to nickel/cobalt metal is 1.02:1.00. The mixture is sintered at 750° C. in an oxygen atmosphere for 10 hours so as to obtain the LiNi_{0.82}Co_{0.18}O₂ cathode material. The as-synthesized LiNi_{0.82}Co_{0.18}O₂ powders are suspended in a 0.3 M NH₄OH solution, and then an appropriate amount of Al₂(SO₄)₃ solution is slowly added into the suspension with continuous stirring for 2 hours. Simultaneously, a 3.0 M NH₄OH solution is fed into the reactor. In order to control the relative supersaturation, the pH and temperature are adjusted to 8.0 and 60° C., respectively. A certain amount of aluminum hydroxide(Al(OH)₃) is uniformly coated on the surface of LiNi_{0.82}Co_{0.18}O₂ by a chemical co-precipitation method and then sintered at 750° C. in an oxygen atmosphere for 3 hours. Thus, the cathode material of lithium nickel cobalt oxide doped with a gradient of aluminum metal indicated by Al(GD)-LNCO is obtained.

2. Manufacturing and measuring the coin cell: Appropriate amounts of active material, graphite/carbon black and PVdF(polyvinylidene fluoride) are prepared according to a weight ratio of 90:6:4, and then NMP is added and mixed to form a uniform slurry. A 150 μm doctor blade is used to spread the slurry on an 18 μm aluminum foil. The coated film as the electrode plate is dried on a hot plate and then further dried in vacuum to remove NMP solvent. Before assembling the coin cell, the electrode plate is roll-pressed and punched to form a circular disk (12 mm) In the coin cell, a disk of lithium metal serves as the anode, and an Al(GD)-LNCO electrode-plate is the cathode. The electrolyte is prepared by mixing 1.0 M LiPF₆ dissolved in EC(ethylene carbonate) and DMC(dimethyl carbonate) solvent at a volume ratio of 1:1. The polyethylene membrane as a separator is soaked in the electrolyte for 24 hours prior to use. The charge/discharge ranges are 2.8˜4.3 V and 2.8˜4.5 V, respectively, and the charge/discharge currents are 0.1 C˜7 C so as to measure various electrochemical properties of the Al(GD)-LNCO cathode material.

3. DSC (differential scanning calorimeter) for the Al(GD)-LNCO cathode material: The coin cell is assembled and charged to 4.3 V. The cell is then dissembled in an argon-filled dry box to take out the cathode electrode, and 3mg of the cathode material is scraped from the cathode plate and placed into an aluminum pan. 3 μL of the electrolyte is added and then the aluminum pan is sealed. DSC scanning is carried out at a scan rate of 5° C. min⁻¹ from 180˜280° C.

### COMPARATIVE EXAMPLE 1

As compared with the cathode material manufactured in the illustrative example 1, the comparative example 1 manufactures the lithium nickel cobalt oxide cathode material without any modification, indicated by LNCO. Specifically, LNCO is synthesized via the following steps: spherical nickel cobalt hydroxide, (Ni_{0.82}Co_{0.18}(OH)₂), is formed by a chemical co-precipitation method; lithium hydroxide is added and mixed at a molar ratio of lithium salt to nickel/cobalt metal being 1.02:1.00; and then the mixture is sintered at 750° C. in an oxygen atmosphere for 13 hours so as to obtain the LiNi_{0.82}Co_{0.18}O₂ cathode material (LNCO). The process of manufacturing the coin cell is the same as that of Al(GD)-LNCO. The LNCO cathode material is also measured by DSC.

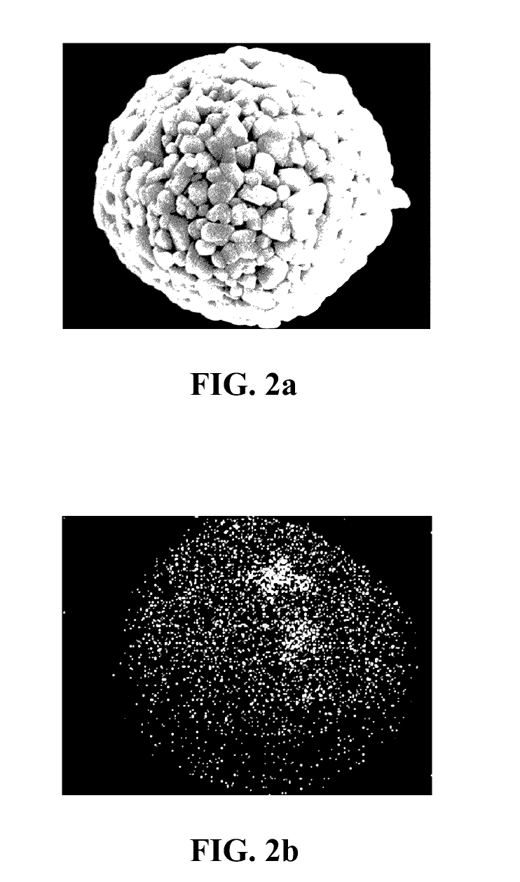

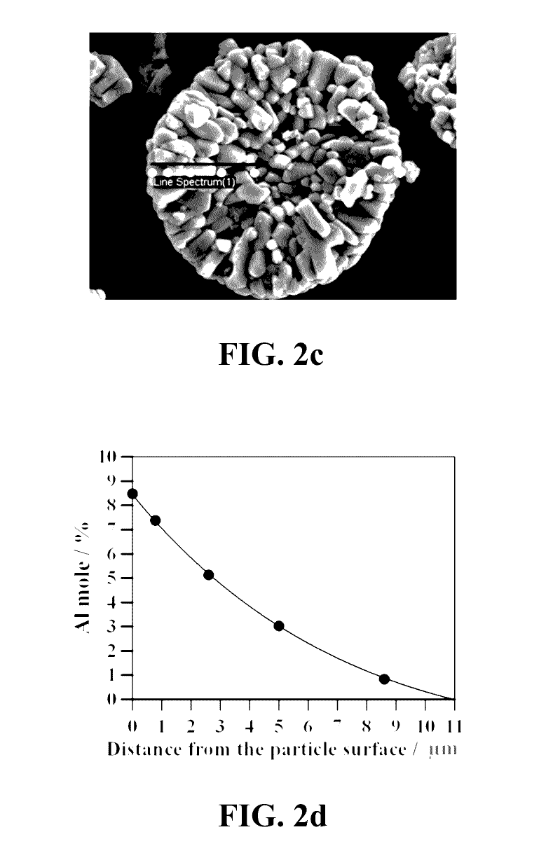

The measurement results of the illustrative example 1 and the comparative example 1 are illustrated in FIGS. 2 to 6.

As for analysis of the physical properties, inductively coupled plasma/optical emission spectrometer (ICP/OES) and scanning electron microscope (SEM) with an energy dispersive spectrometer (EDS) are used to measure the quantitative element analysis for the bulk, surface and cross section of the Al(GD)-LNCO cathode material of the illustrative example 1. For example, the average molar percentage of aluminum element doped in lithium nickel cobalt oxide is 2.55% measured by ICP/OES. FIG. 2a indicates the surface morphology of the Al(GD)-LNCO cathode material, and FIG. 2b is the aluminum profile on the surface of the Al(GD)-LNCO cathode material, presenting that high content of aluminum exists on the surface. Additionally, FIG. 2c is the cross section morphology of the Al(GD)-LNCO cathode material, indicating that each particle is made of numerous dense primary particles and no boundary or layered structure exists in the particle, and FIG. 2d shows the quantitative aluminum distribution in the rupture surface (cross section) of the Al(GD)-LNCO cathode material. It is obvious that the aluminum doping content on the surface is 8.48%, and the aluminum doping content at a distance of 8.5 μm from the surface decreases to 0.83%. Also, the aluminum profile of concentration is specifically configured to decrease in a continuous variation from the surface to the core of particle.

For analysis of electrochemical properties, the differences between the Al(GD)-LNCO cathode material in illustrative example 1 and the LNCO cathode material in the comparative example 1 are clearly shown in FIG. 3, which illustrates the charge/discharge curves at 0.1 C. Within a voltage range of 2.8˜4.3 V, the discharge capacity and the irreversible capacity for the Al(GD)-LNCO cathode material are 182.7 mAh g⁻¹ and 35.1 mAh g⁻¹, respectively, and the discharge capacity and the irreversible capacity for the LNCO cathode material are 184.8 mAh g⁻¹ and 33.2 mAh g⁻¹, respectively. In addition, if the voltage range increases up to 2.8˜4.5 V, the discharge capacity and the irreversible capacity for the Al(GD)-LNCO cathode material are 197.8 mAh g⁻¹ and 36.0 mAh g⁻¹, respectively, and the discharge capacity and the irreversible capacity for the LNCO cathode material are 191.2 mAh g⁻¹ and 54.3 mAh g⁻¹, respectively.

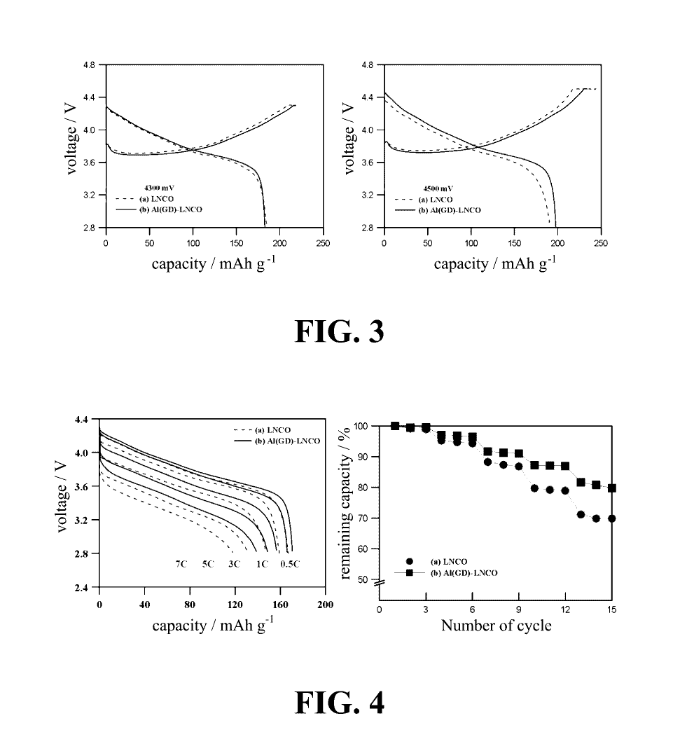

Moreover, FIG. 4 illustrates the charge/discharge curves for the illustrative example 1 and the comparative example 1 at different conditions of charge/discharge current, including 0.2 C of charge current, 0.5 C˜7 C of discharge current, and 2.8˜43 V of working voltage. It is obvious from FIG. 4 that the Al(GD)-LNCO cathode material of the illustrative example 1 has a higher potential plateau and a 82.06% original capacity even at 7 C of discharge current, but the LNCO cathode material of the comparative example 1 has only 71.1% original capacity.

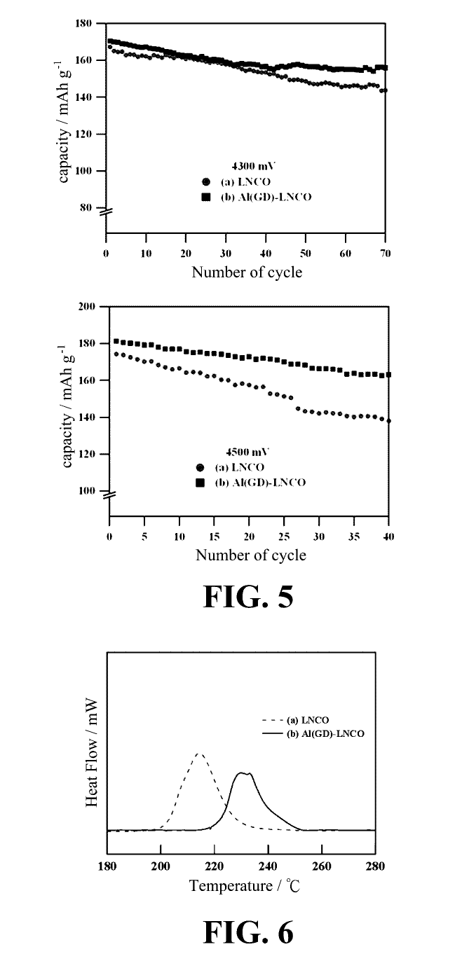

Refer to FIG. 5 showing the result of the cycle life for the illustrative example 1 and comparative example 1 at 0.5 C charge/discharge current, 2.8˜4.3 working voltage and 70 cycles of charge/discharge. The Al(GD)-LNCO cathode material of the illustrative example 1 still keeps 91.11% capacity retention, but the LNCO cathode material of the comparative example 1 has only 85.75% capacity retention. If the range of working voltage changes to 2.8˜45 V at 0.5 C charge/discharge current after 70 cycles, the Al(GD)-LNCO cathode material still has 89.98% capacity retention, but the LNCO cathode material only 79.23% capacity retention.

Form the above mentioned, the Al(GD)-LNCO cathode material of the illustrative example 1 is better than the LNCO cathode material of the comparative example 1 in terms of electrochemical properties.

Further refer to FIG. 6 showing the DSC test results for the illustrative example 1 and comparative example 1. The LNCO cathode material of the comparative example 1 has an exothermic temperature of about 214.3° C., but the Al(GD)-LNCO cathode material of the illustrative example 1 has a higher exothermic temperature of about 229.9° C. and an exothermic heat from 855.06 J g⁻¹ down to 591.76 J g⁻¹. Thus, it is proved that the Al(GD)-LNCO cathode material exhibits better thermal stability.

### ILLUSTRATIVE EXAMPLE 2

1. Synthesis of the lithium nickel cobalt manganese oxide cathode material gradient-doped with magnesium as the modifying metal: An aqueous solution of 1.2 M NiSO₄, CoSO₄ and MnSO₄ (molar ratio of Ni:Co:Mn≈5:2:3) is pumped into a tank reactor (capacity, 2 L) with continuous stirring. Simultaneously, a 2.0 M NaOH solution and an 8.0 M NH₄OH solution, which is used as a chelating agent, are fed separately into the reactor. The concentration of NH₄OH, pH and temperature are maintained at 1.2 M, 10.5 and 60° C., respectively. After vigorous stirring for 20 hours, spherical Ni_{0.51}Co_{0.20}Mn_{0.29}(OH)₂ precipitations with particle diameters of approximately 10˜15 μm are formed. After spherical nickel cobalt manganese hydroxide (Ni_{0.51}Co_{0.20}Mn_{0.29}(OH)₂) is synthesized by a chemical co-precipitation method, a sintering process is performed at 600° C. in an oxygen atmosphere for 10 hours to obtain the spherical nickel cobalt manganese oxide, and then lithium hydroxide (LiOH.H₂O) is added and mixed at a molar ratio of lithium salt to nickel/cobalt/manganese metal being 1.02:1.00. The mixture is sintered at 850° C. in an oxygen atmosphere for 18 hours to obtain the LiNi_{0.51}Co_{0.20}Mn_{0.29}O₂ cathode material. The as-synthesized LiNi_{0.51}Co_{0.20}Mn_{0.29}O₂ powders are suspended in a 1.0 M NH₄OH solution, and then an appropriate amount of MgSO₄ solution is slowly added into the suspension with continuous stirring for 1 hour. Simultaneously, a 0.5 M NaOH solution and a 6.5 M NH₄OH solution are fed separately into the reactor. In order to control the relative supersaturation, the pH and temperature are adjusted to 11.0 and 60° C., respectively. A certain amount of magnesium hydroxide(Mg(OH)₂) is uniformly coated on the surface of LiNi_{0.51}Co_{0.20}Mn_{0.29}O₂ by a chemical co-precipitation method and then sintered at 850° C. in an oxygen atmosphere for 2 hours so as to obtain the cathode material of lithium nickel cobalt manganese oxide doped with a gradient of magnesium metal indicated by Mg(GD)-LNCMO.

2. Manufacturing and measuring the coin cell: Appropriate amounts of active material, graphite/carbon black, and PVdF (polyvinylidene fluoride) are prepared according to a weight ratio of 91:6:3, and then NMP is added and mixed to form a uniform slurry. A 150 μm doctor blade is used to spread the slurry on an 18 μm aluminum foil. The coated film as the electrode plate is dried on a hot plate and then further dried in vacuum to remove NMP solvent. Before assembling the coin cell, the electrode plate is roll-pressed and punched to form a circular disk (12 mm). In the coin cell, a disk of lithium metal serves as the anode, and a Mg(GD)-LNCMO electrode-plate is the cathode. The electrolyte is prepared by mixing 1.0 M LiPF₆ dissolved in EC and DMC solvent at a volume ratio of 1:1. The polyethylene membrane as a separator is soaked in the electrolyte for 24 hours prior to use. The charge/discharge ranges are 2.8˜4.3 V and 2.8˜4.5 V, respectively, and the charge/discharge currents are 0.1 C˜7 C so as to measure various electrochemical properties of the Mg(GD)-LNCMO cathode material.

3. DSC (differential scanning calorimeter) for the Mg(GD)-LNCMO cathode material: The coin cell is assembled and charged to 4.5 V. The cell is then dissembled in an argon-filled dry box to take out the cathode electrode, and 3 mg of the cathode material is scraped from the cathode plate and placed into an aluminum pan. 3 μL of the electrolyte is added and then the aluminum pan is sealed. DSC scanning was carried out at a scan rate of 5° C. min⁻¹ from 220˜300° C.

### COMPARATIVE EXAMPLE 2

As compared with the cathode material manufactured in the illustrative example 2, the comparative example 2 manufactures the lithium nickel cobalt manganese oxide cathode material without any modification, indicated by LNCMO. Specifically, LNCMO is synthesized via the following steps: spherical nickel cobalt manganese hydroxide, (Ni_{0.51}Co_{0.20}Mn_{0.29}(OH)₂), is formed by a chemical co-precipitation method; spherical nickel cobalt manganese hydroxide is sintered at 600° C. in an oxygen atmosphere for 10 hours to obtain the spherical nickel cobalt manganese oxide; lithium hydroxide is added and mixed at a molar ratio of lithium salt to nickel/cobalt/manganese metal being 1.02:1.00; and then the mixture is sintered at 850° C. in an oxygen atmosphere for 20 hours so as to obtain the LiNi_{0.51}Co_{0.20}Mn_{0.29}O₂ cathode material (LNCMO). The subsequent process of manufacturing the coin cell is the same as that of Mg(GD)-LNCMO. The LNCMO cathode material is also measured by DSC.

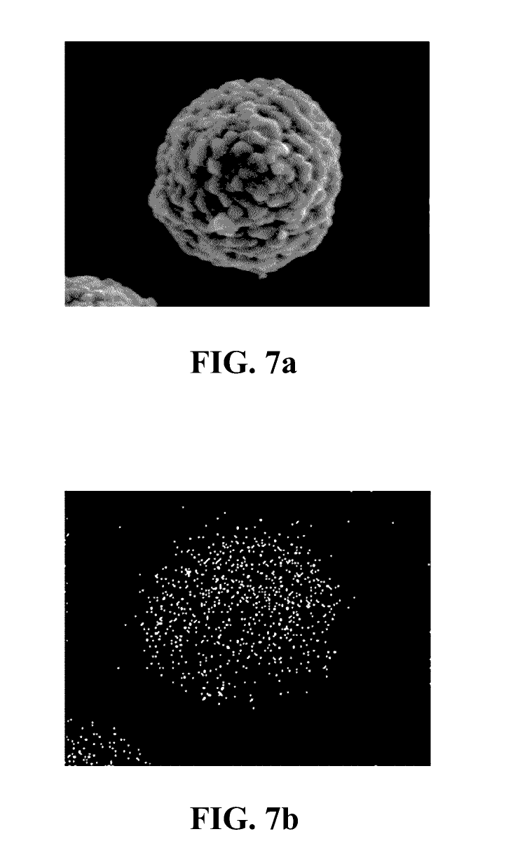

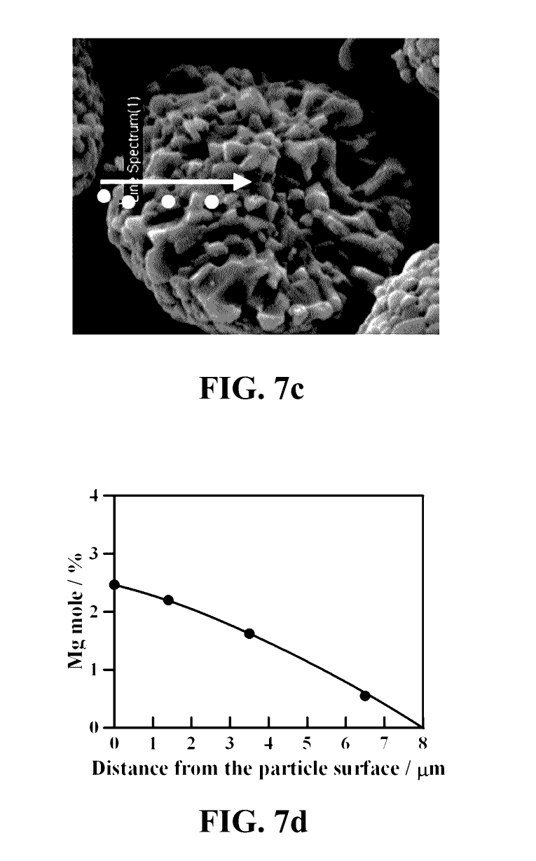

The measurement results of the illustrative example 2 and the comparative example 2 are illustrated in FIGS. 7 to 11.

As for analysis of the physical properties, ICP/OES and SEM with EDS are used to measure the quantitative element analysis for the bulk, surface and cross section of the Mg(GD)-LNCMO cathode material of the illustrative example 2. The average molar percentage of magnesium element doped in lithium nickel cobalt manganese oxide is 1.7% measured by ICP/OES. FIG. 7a indicates the surface morphology of the Mg(GD)-LNCMO cathode material, and FIG. 7b is the magnesium profile on the surface of the Mg(GD)-LNCMO cathode material, presenting that high content of magnesium exists on the surface. Additionally, FIG. 7c is the cross section morphology of the Mg(GD)-LNCMO cathode material, indicating that each particle is made of numerous dense primary particles and no boundary or layered structure exists in the particle, and FIG. 7d shows the quantitative magnesium distribution in the rupture surface (cross section) of the Mg(GD)-LNCMO cathode material. It is obvious that the magnesium doping content on the surface is 2.5%, and the magnesium doping content at a distance of 6.5 μm from the surface decreases to 0.5%. Also, the magnesium profile of concentration is specifically configured to decrease in a continuous variation from the surface to the core of particle.

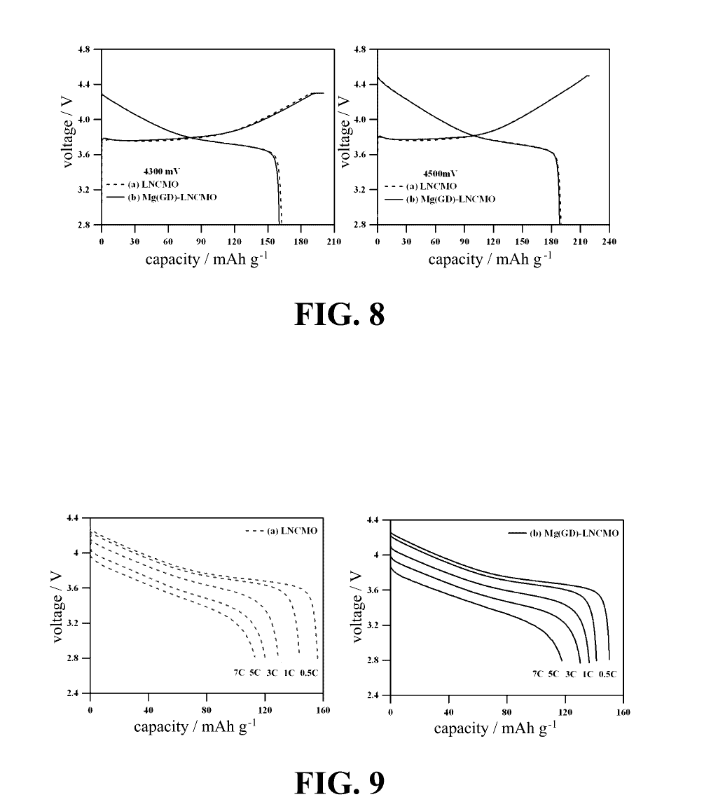

For analysis of electrochemical properties, the differences between the Mg(GD)-LNCMO cathode material in illustrative example 2 and the LNCMO cathode material in the comparative example 2 are clearly shown in FIG. 8, which illustrates the charge/discharge curves at 0.1 C. Within a voltage range of 2.8˜4.3 V, the discharge capacity and the irreversible capacity for the Mg(GD)-LNCM cathode material are 160.3 mAh g⁻¹ and 40.1 mAh g⁻¹, respectively, and the discharge capacity and the irreversible capacity for the LNCMO cathode material are 162.6 mAh g⁻¹ and 30.2 mAh g⁻¹, respectively. If the voltage range increases up to 2.8˜4.5 V, the discharge capacity and the irreversible capacity for the Mg(GD)-LNCMO cathode material are 188.3 mAh g⁻¹ and 30.0 mAh g⁻¹, respectively, and the discharge capacity and the irreversible capacity for the LNCMO cathode material are 189.9 mAh g⁻¹ and 29.2 mAh g⁻¹, respectively. Moreover, FIG. 9 illustrates the charge/discharge curves for the illustrative example 2 and the comparative example 2 at different conditions of charge/discharge current, including 0.2 C of charge current, 0.5 C˜7 C of discharge current, and 2.8˜43 V of working voltage. It is obvious from FIG. 9 that the Mg(GD)-LNCMO cathode material of the illustrative example 2 has a higher potential plateau and a 78.4% original capacity even at 7 C of discharge current, but the LNCMO cathode material of the comparative example 2 has only 72.5% original capacity.

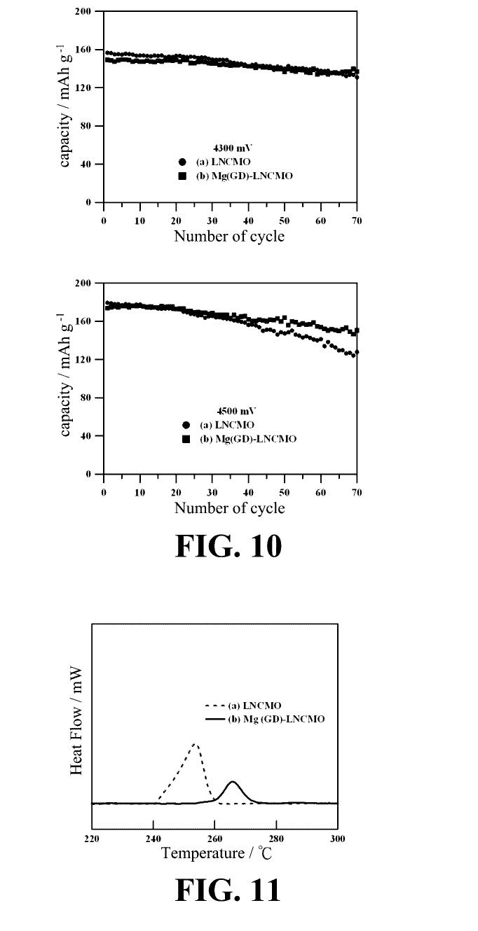

Further refer to FIG. 10 showing the result of the cycle life for the illustrative example 2 and comparative example 2 at 0.5 C charge/discharge current, 2.8˜43 working voltage and 70 cycles of charge/discharge. The Mg(GD)-LNCMO cathode material of the illustrative example 2 still keeps 91.7% capacity retention, but the LNCMO cathode material of the comparative example 2 has only 83.6% capacity retention. If the range of working voltage changes to 2.8˜45 V, at 0.5 C charge/discharge current after 70 cycles, the Mg(GD)-LNCMO cathode material still has 86.7% capacity retention, but the LNCMO cathode material only 71.3% capacity retention.

Form the above mentioned, the Mg(GD)-LNCMO cathode material of the illustrative example 2 is better than the LNCMO cathode material of the comparative example 2 in terms of electrochemical properties.

Also, refer to FIG. 11 showing the DSC test results for the illustrative example 2 and comparative example 2. The LNCMO cathode material of the comparative example 2 has an exothermic temperature of about 254° C., but the Mg(GD)-LNCMO cathode material of the illustrative example 2 has a higher exothermic temperature of about 266° C. and an exothermic heat from 227.3 J g⁻¹ down to 115.9 J g⁻¹. Thus, it is proved that the Mg(GD)-LNCMO cathode material exhibits better thermal stability.

More specifically, the secondary lithium battery using the cathode material of the present invention may comprise a shell formed of stainless steel, aluminum or aluminum alloy with a shape of circular, rectangular or cylinder. The present invention also applicable to polymer lithium batteries packaged by aluminum foil thermal sealing or other packaging types so as to increase the safety of operation and performances of battery.

From the above mention, one primary feature of the present invention is that the metal gradient-doped hexagonal-crystalline cathode material employs the modifying metal more concentrated on the surface of the cathode powder to reduce the reactivity with the electrolyte, and the modifying metal is specifically configured to gradually decrease toward the core to reduce the doping amount of the modifying metal such that both high capacity and long cycle-life at higher working voltage are implemented, and the industrial utility of the high energy-density cathode material is greatly improved. As a result, the cathode material of the present invention is very applicable to the cathode of the lithium battery.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A metal gradient-doped cathode material served as a powder used for lithium batteries, comprising a hexagonal-crystalline material body and a modifying metal or metalloid, wherein the hexagonal-crystalline material body is doped with the modifying metal or metalloid in a gradient of concentration, the metal gradient-doped cathode material is specified by a chemical formula “f mol % M doped Li_{z}NiₐCo_{b}Mn_{c}O₂”, Li_{z}NiₐCo_{b}Mn_{c}O₂ represents the hexagonal-crystalline material body as an active component of cathode material, the hexagonal-crystalline material body comprises a lithium metal oxide of a single metal selected from Ni (nickel) and Co (cobalt), or two metals selected from Ni/Co, Ni/Mn (manganese) and Co/Mn, or three metals comprising Ni, Co and Mn, where z, a, b and c in the chemical formula are specified by 0.9≦z≦1.2, a+b+c=1, 0≦a≦1, 0≦b≦1 and 0≦c≦0.6, M represents the modifying metal or the metalloid comprising at least one of magnesium (Mg), calcium (Ca), strontium (Sr), boron (B), aluminum (Al), gallium (Ga), indium (In), titanium (Ti), silicon (Si) and tin (Sn), f indicates a molar content of the modifying metal or the metalloid, and is larger than 0.5% and smaller than 10% of a total molar content of Ni, Co and Mn in the hexagonal-crystalline material body, specified by 0.5% (a+b+c)≦f≦10% (a+b+c), and the metal gradient-doped cathode material is formed by coating modifying metal hydroxide on the surface of the hexagonal-crystalline material using a chemical co-precipitation method, then sintering the modifying metal hydroxide coated hexagonal-crystalline material.

2. The metal gradient-doped cathode material as claimed in claim 1, wherein the powder does not have any boundary or layered structure in the particle.

3. The metal gradient-doped cathode material as claimed in claim 1, wherein the modifying metal on the surface of the powder, is expressed as f′, has a concentration larger than a concentration of the modifying metal at a core of the powder, is expressed as f″, the concentration of the modifying metal continuously decreases from the surface toward the core of the powder particle, a stoichiometric factor of Ni, Co and Mn on the surface of the powder is smaller than the stoichiometric factor of Ni, Co and Mn at the core, the concentrations of Ni, Co and Mn continuously increase from the surface of the powder toward the core of the powder, and the concentration ranges of modifying metal are f′>f>f″>0 and f′−f″>0.2% (a+b+c).

4. The metal gradient-doped cathode material as claimed in claim 1, further comprising a R-3m space group.

5. The metal gradient-doped cathode material as claimed in claim 1, wherein the powder has a D₅₀ particle size of 0.5-25 μm.

6. The metal gradient-doped cathode material as claimed in claim 1, wherein the powder has a tap density larger than 1.5 g cm ³.

7. The metal gradient-doped cathode material as claimed in claim 1, wherein the powder has a specific surface area of 0.1˜25 m² g⁻¹.

8. The hexagonal-crystalline material material as claimed in claim 1, wherein the hexagonal-crystalline material is synthesized via a chemical co-precipitation route.

9. The metal gradient-doped cathode material as claimed in claim 1, wherein the hexagonal-crystalline material is coated modifying metal hydroxide by a chemical co-precipitation method, a molar ratio of modifying metal hydroxide and hexagonal-crystalline material is 0.005˜0.100:1.000, and the modifying metal hydroxide coated hexagonal-crystalline material is sintered at 600˜1000° C. for 1˜6 hours.
